(19) United States
(12) Patent Application Publication
(10) Pub. No.: US 2011/0165316 A1
(43) Pub. Date: Jul. 7, 2011

(54) PLANT FOR FORMING ELECTRONIC CIRCUITS ON SUBSTRATES

(75) Inventor: Andrea Baccini, Frazione Olmi (IT)

(73) Assignee: Applied Materials Italia S.R.L., San Biagio Di Callalta (IT)

(21) Appl. No.: 12/997,698

(22) PCT Filed: Jun. 12, 2009
(86) PCT No.: PCT/EP2009/057317

§ 371 Date: Feb. 10, 2011

(30) Foreign Application Priority Data
Jun. 13, 2008 (IT) UD2008A000136

(51) Int. Cl. B05D 3/00; B05C 11/00; B05C 9/12; B05D 3/06

(52) U.S. Cl. 427/8; 118/712; 427/532

(57) ABSTRACT

Embodiments of the present invention generally provide a cluster tool 10 that can be used to form electronic circuits on a substrate in an automated fashion. In one embodiment, the cluster tool 10 is adapted to process portions of a substrate to form part of a photovoltaic cell or a green-tape type circuit device in an automated fashion using a system controller 101. In one embodiment, the cluster tool 10 having plurality of work stations that comprise at least one station to deposit a layer on a substrate, a drying oven to dry the substrates, a testing station to test the substrates, and a storage station to store the substrates, and a transport element that is positionable in each of the work stations. A guide defines a substantially closed circuit along which a plurality of transport elements are able to be moved, on each of which at least one of the substrates is disposed.

### BACKGROUND OF THE INVENTION

1. Field of the Invention

The present invention concerns a cluster tool used to form electronic circuits, having a defined geometric shape on a substrate formed from, for example, a material such as silicon or alumina. In particular the cluster tool, comprising a plurality of work stations associated and coordinated with each other, is preferably but not restrictively used to make photovoltaic cells and green-tape type circuits.

2. Description of the Background Art

Cluster tools having a plurality of work stations that are used to process and/or form electronic circuits on a substrate, such as silicon or alumina, are known. In particular such work stations comprise at least a station for loading the substrates, a station that is able to deposit a metal layer on a substrate, at least an oven in which the metalized substrates are subjected to a drying process, at least one testing station to carry out a qualitative test on the substrates so produced, and at least a storage station in which said substrates are stored according to their qualitative class.

During processing in these conventional cluster tools, the substrates are typically moved one by one and in sequence from the loading station to the metal deposit station and then to the following work station by a movement means, such as conveyor belts for example. One disadvantage of these known types of cluster tools is that the individual and sequential feed of the substrates causes a reduction in the substrate throughput, in particular in correspondence with the work stations that have a longer processing times, such as for example the metal deposition stations. This limits the production capacity of the cluster tool and causes longer production times and therefore higher energy consumption and increased production cost.

Moreover these conventional cluster tools only generally contain a substrate identification device, which is disposed in a storage station contained within the cluster tool. The storage station identification device will generally have a recognition means, in which the substrates are stored in suitable containers provided within the said identification means.

Therefore, there exists a need for a cluster tool that reduces energy consumption, reduces production time, increases production capacity, and allows a continuous monitoring of the substrates both during the production cycle, and also when the processing is finished. The Applicant has devised, tested and created the present invention to overcome the shortcomings of the state of the art and to obtain these and other purposes and advantages.

### SUMMARY OF THE INVENTION

Embodiments of the present invention provide a cluster tool that is configured to process a plurality of substrates, comprising an automation assembly comprising a plurality of transport elements that each have a substrate supporting surface, and a guide forming a substantially closed circuit through the cluster tool, and having an actuator that is adapted to move the plurality of transport elements along the substantially closed circuit, at least one deposition station that is adapted to deposit a layer on a surface of a substrate disposed on a substrate supporting surface of a transport element, at least one drying oven that is adapted to dry the deposited layer formed on the substrate disposed on the substrate supporting surface of the transport element, and an inspection station that is adapted to optically inspect a surface of the substrate disposed on the substrate supporting surface of the transport element.

Embodiments of the invention may further provide a method of processing a substrate, comprising positioning a substrate on a substrate supporting surface formed on a transport element, wherein positioning a substrate comprises receiving a substrate on a first surface of a belt that is disposed over the substrate supporting surface, and moving the belt across the substrate supporting surface, transferring the substrate disposed on the first surface of the belt disposed over the substrate supporting surface of the transport element along a closed circuit formed along a guide, depositing a material layer on a surface of the substrate disposed on the substrate supporting surface of the transport element, transferring the substrate disposed on the substrate supporting surface of the transport element to a processing region of a drying chamber after depositing the material layer, delivering an amount of electromagnetic energy to a surface of the substrate positioned on the substrate supporting surface of the transport element, and delivering a heated gas past the surface of the substrate positioned on the substrate supporting surface of the transport element.

In accordance with the above purposes, embodiment of the present invention may also generally provide a cluster tool for processing substrates in a production station having a plurality of work stations, in which the work stations comprise at least a station to deposit metal on the substrates, at least a drying oven to dry the substrates, at least a testing station of the substrates, and at least a storage station to store the substrates, and movement means able to move the substrates through the work stations. The substrates may comprise a silicon or an alumina based material that may be used in a photovoltaic or a green-tape circuit type device. Advantageously said work stations also comprise at least an optical inspection station for the substrates, and at least a sintering oven for the substrates.

According to an advantageous feature of the present invention, the cluster tool comprises a plurality of production stations that are disposed along said closed circuit. The use of a closed circuit along which numerous transport elements move, and the presence of a plurality of production stations along the same circuit, allow to processing of several substrates at the same time and in parallel. This configuration is believed to provide greater production capacity of the cluster tool. According to a characteristic feature of the present invention, the movement means define a substantially closed circuit, along which a plurality of transport elements are able to be moved, and on each of which at least one of the substrates is disposed. The number of production stations that can be positioned along the same closed circuit depends on the production capacity which is needed, therefore the cluster tool according to the present invention is modular and is therefore can be configured to meet different production capacity requirements.

Advantageously the movement means comprise at least an electromagnetic guide, along which a plurality of transport elements are able to move at a higher speed than that of a conventional conveyor belt. This allows the processing times of each individual substrate to be reduced. According to another advantageous feature of the present invention, each transport element also comprises a drive member to actuate the movement of each transport element.

Advantageously, each transport element comprises heating means, able to heat the substrate transported in order to take it to a determinate operating temperature, and lighting means disposed under said belt to determine a rear-lighting effect. According to a variant of the present invention each transport element comprises suction means, disposed in cooperation with said belt and able to hold each substrate in a determinate operating position.

Advantageously, each of the substrates is provided with identification elements, for example radio frequency, magnetic induction or other type, identification element that can be used by a recognition device disposed in each of the work stations to monitor the position of the substrate in the cluster tool.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic representation of a first form of embodiment of a cluster tool according to the present invention;

FIG. 2 illustrates a detail of FIG. 1 according to one embodiment of the invention;

FIG. 3 illustrates a detail of FIG. 2 according to one embodiment of the invention;

FIG. 4 is a schematic representation of one embodiment of a cluster tool according to the present invention;

FIG. 5 is a schematic representation of one embodiment of a cluster tool according to the present invention.

FIG. 6 is a side cross-sectional view of a drying chamber according to one embodiment of the invention;

FIG. 7 is another side cross-sectional view of the drying chamber according to FIG. 6.

To facilitate understanding, identical reference numerals have been used, where possible, to designate identical elements that are common to the figures. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

### DETAILED DESCRIPTION

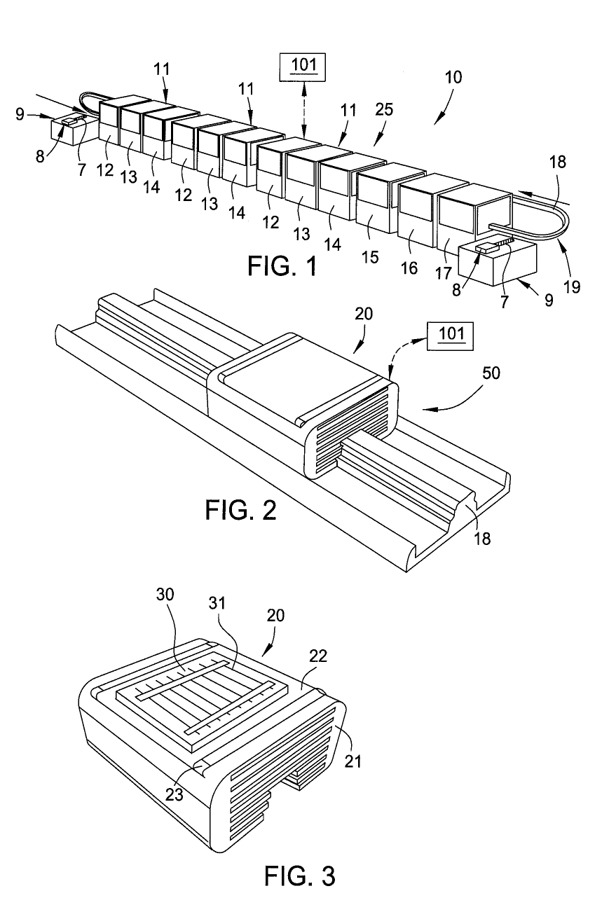

Embodiments of the present invention generally provide a cluster tool 10 that can be used to form electronic circuits on a substrate in an automated fashion. In one embodiment, the cluster tool 10 is adapted to process portions of a substrate to form part of a photovoltaic cell or a green-tape type circuit device in an automated fashion using a system controller 101. In one embodiment, as shown in FIG. 1, the cluster tool 10 comprises a work station 11, which comprises a deposition station 12 that can be used to deposit a metal or dielectric layer on a substrate.

In one embodiment, the deposition station 12 comprises a screen print chamber that is adapted to deposit a material in a desired pattern on the surface of the substrate. An exemplary screen printing chamber that may be adapted to deposit a material layer on a surface of a substrate disposed on a transport shuttle 20 (discussed below) is further described in the commonly assigned U.S. patent application Ser. No. 12/257,159 [Attorney Docket No. APPM 13565], PCT Patent Application Number PCT/IT2006/000228, filed Mar. 31, 2006, and Italian Patent Application Number UD2009A000043, entitled “Autotuned Screen Printing Process” [Atty. Docket No.: APPM/139741T], filed Feb. 23, 2009, which are all incorporated by reference in their entirety. In one embodiment, the screen print chamber includes a plurality of actuators that are in communication with the system controller 101 and are used to adjust the position and/or angular orientation of a screen printing mask (not shown) with respect to a substrate 30 disposed on a transport shuttle 20 (FIG. 3) during the screen printing process. The screen printing mask is generally a metal sheet or plate that has a plurality of features, such as holes, slots, or other apertures formed therethrough to define a pattern and placement of screen printed material (i.e., ink or paste) on a surface of a substrate. In general, the screen printed pattern that is to be disposed on the surface of a substrate is aligned to the substrate in an automated fashion by orienting the screen printing mask over the substrate surface using the actuators and control signals sent by the system controller 101, before a paste material is delivered through the features formed in the printing mask. In one embodiment, the deposited layer is a metal containing layer that can be used to form conductor tracks 31 (FIG. 3) on a surface of a solar cell substrate.

The system controller 101 is generally designed to facilitate the control and automation of the overall cluster tool 10 and typically may include a central processing unit (CPU) (not shown), memory (not shown), and support circuits (or I/O) (not shown). The CPU may be one of any form of computer processors that are used in industrial settings for controlling various chamber processes and hardware (e.g., transport shuttle 20, RF ID devices, conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 101 determines which tasks are performable on a substrate. Preferably, the program is software readable by the system controller 101, which includes code to generate and store at least substrate positional information, the sequence of movement of the various controlled components, substrate inspection system information, and any combination thereof.

The work station 11 may also comprise, downstream of the deposition station 12, an automated optical inspection station 13 that is able to inspect and analyze the substrates exiting the deposition station 12 to assure that there are no deposited layer to substrate positioning errors, or defects in the deposited layer (e.g., line breaks, smudges). The optical inspection station 13 in combination with the system controller 101 is generally used to perform the inspection and analysis of the substrates received from the deposition station 12 by use of a transport shuttle 20, which is discussed below. The automated optical inspection station 13 generally contains one or more inspection assemblies that can be used to inspect one or more substrates moved to a desired position within the automated optical inspection station 13. The data for each inspected substrate can then be used by the system controller 101 to control the subsequent processes performed in the deposition station 12. In one example, the information collected by the automated optical inspection station 13 is used to position and orient the screen print head components found in a screen printing chamber disposed in the deposition station 12. In this case, the position of a screen printing head in the deposition station 12 can be automatically adjusted to align a screen print mask (not shown) to a substrate, based on the data received by the system controller during a prior inspection process. In another example, based on the data collected during the inspection process, the automated optical inspection station 13 is configured to warn a user that the processing components in the deposition station 12 are not performing as desired. In general, an inspection assembly may include one or more cameras positioned to inspect an incoming, or processed substrate 30 disposed on the transport shuttle 20. In one embodiment, the inspection assembly includes at least one camera (e.g., CCD camera) and other electronic components capable of inspecting and communicating the inspection results to the system controller 101. An example of an inspection assembly that may be adapted to perform one or more of the inspection steps described herein is further described in the commonly assigned U.S. patent application Ser. No. 12/418,912, filed Apr. 6, 2009, and the previously cited Italian Patent Application entitled “Autotuned Screen Printing Process” [Atty. Docket No.: APPM/139741T], filed Feb. 23, 2009, which are both incorporated by reference in their entirety.

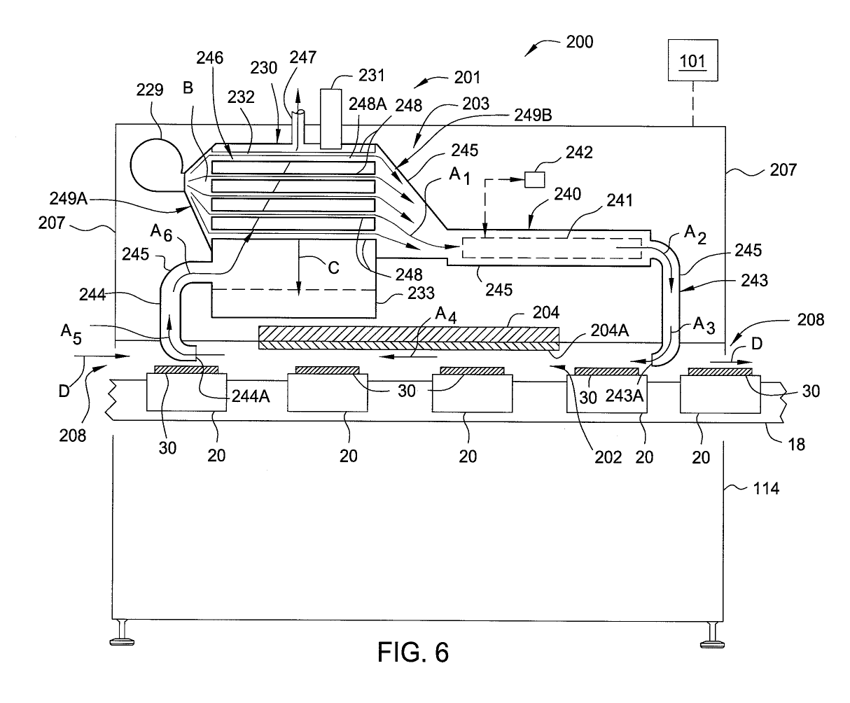

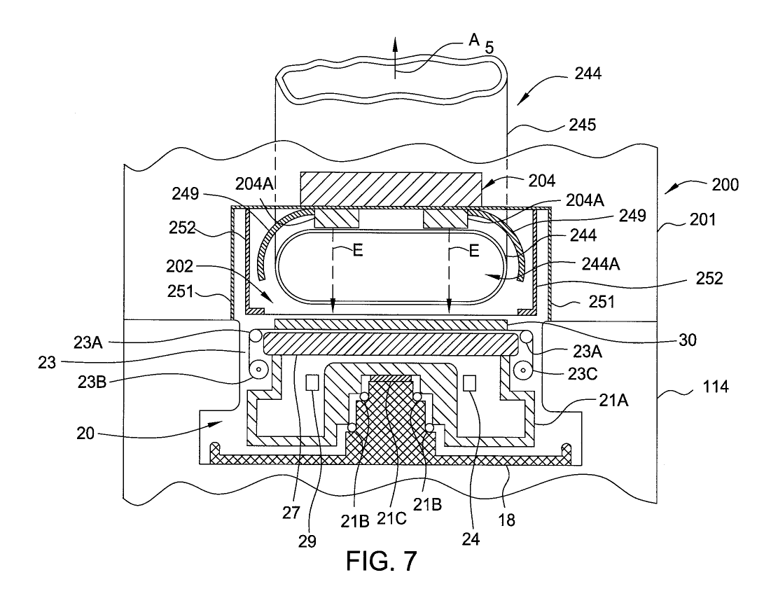

The work station 11 may also comprise a drying oven 14, which is downstream of the automatic optical inspection station 13, that is able to subject a substrate to a drying process, for example of the type with UV rays, or laser type, or another type, to dry the deposited material formed on a surface of the substrate. FIG. 6 generally illustrates one embodiment of a drying oven 14 that may be used in the cluster tool 10. In this configuration, the drying oven 14 may contain a drying chamber 200 that is positioned to receive a substrate transported from the automated optical inspection station 13 by use of the transport shuttle 20. FIGS. 6-7 generally illustrate one or more embodiments of a drying chamber 200, which is further described below. In general, the drying chamber 200 contains a processing region 202 in which energy is delivered from a thermal system 201 to one or more substrates positioned therein, so that the material deposited on a surface of the one or more substrates can be dried. In one example, the deposited material is an aluminum (Al) containing paste, such as a lead free aluminum cermet paste (e.g., Al Cermet 6214) that are commonly used in solar cell production processes to form the backside contacts on a crystalline solar cell substrate. In another example, the deposited material may be a silver (Ag) paste used on the front side of a solar cell (e.g., PV 156 made by DuPont™) or a silver-aluminum (Ag/Al) paste (PV202 from DuPont™) used on the back side of a solar cell. The processing region 202 is coupled to one or more transport shuttles 20 that are adapted to move and/or position the substrate 30 within the processing region 202.

FIG. 6 is a side cross-sectional view of one embodiment of the thermal system 201 contained in the drying chamber 200. The thermal system 201 generally comprises a radiant heating assembly 204 and a convective heating assembly 203 that are used together to rapidly dry the material deposited on the surface of the substrate. In this configuration, convective and radiative heat transfer modes can be separately controlled to achieve a desired thermal profile (e.g., temperature versus time) during the drying process to improve throughput and reduce energy consumption. In one embodiment, the substrate temperature during the drying process is raised to between about 150° C. and about 300° C. In general, it is desirable not to exceed the temperature at which the binders in the deposited material break down (e.g., 300-350° C.) to prevent damage to the formed pattern on the substrate.

In one configuration, as shown in FIG. 6, one or more substrates 30 are transferred through the processing region 202 following path “D” using the transport shuttle 20, discussed below. The transport shuttle 20 is generally an automated substrate handling devices that is used to transfer one or more substrates through the processing region 202.

The radiant heating assembly 204 generally contains one or more electromagnetic energy delivering devices that are used to provide energy to the substrates positioned on the transport shuttle 20 as they pass through the processing region 202. In one embodiment, the electromagnetic energy delivering device comprises one or more lamps 204A that are adapted to and/or selected to deliver radiation at one or more desirable wavelengths to the substrate 30. The wavelength(s) of the radiant energy delivered from the radiant heating assembly 204 is generally selected so that it is absorbed by the material deposited on the surface of the substrate. However, in cases where the thermal budget of the processed substrate is an issue, such as semiconductor substrates, solar cells, or other similar devices, it may be desirable to limit the wavelengths of the radiant energy delivered to substrate so that the radiant energy is preferentially absorbed by the deposited material and generally not by the material from which the substrate is made. In one example, in cases where the substrate is made from a silicon (Si) containing material the wavelength of the energy delivered by an lamps 204A may be adjusted or filtered so that only wavelengths greater than the absorption edge of silicon, which is generally about 1.06 (μm), are delivered to reduce the amount of energy absorbed by the silicon substrate.

In one embodiment, the optimal wavelengths delivered by the radiant heating assembly 204 are selected and/or adjusted for each type of substrate and each type of material deposited on a surface of the substrate to improve the absorption of the delivered energy, and thus the drying process of the deposited material. In one embodiment, the lamps 204A are infrared (IR) lamps that have a maximum operating temperature between about 1200 and 1800° C. and have a maximum power emission at wavelengths greater than about 1.4 μm. In one example, the lamps 204A are a double filament 5 kW fast medium wave IR lamp that is about 1 meter long, which is available from Heraeus Nobelight GmbH of Hanau, Germany. In some cases it is desirable to adjust the wavelength(s) of the emitted radiation from the lamps 204A by adjusting the power delivered to the lamps and thus the temperature of the filament within the lamp (e.g., Wien's law). Therefore, by use of the system controller 101, a power supply (not shown) coupled to the lamps 204A, and knowledge of the optical absorption characteristics of the deposited material on the surface of the substrate, the wavelengths of the delivered energy by the lamps 204A can be adjusted to improve the drying process.

FIG. 7 illustrates one embodiment of the radiant heating assembly 204 that utilizes two lamps 204A that are positioned within and extend along a desired length of the processing region 202 (FIG. 6). In this configuration, the lamps 204A are positioned to transfer energy (path “E”) to one or more substrates positioned on the transport shuttle 20 in the processing region 202 as the one or more substrates are transferred the length of the lamp 204A during the drying process. In some cases it may be desirable to provide one or more reflectors 249 above the lamps 204A to reduce the amount of heat being transferred to other unwanted portions of the thermal system 201 and focus the energy towards the substrate 30.

The thermal system 201 also utilizes the convective heating assembly 203 to transfer heat to a substrate using a convective heat transfer method, such as delivering a heated gas (e.g., air) across the surface of the substrate that is positioned in the processing region 202. Convective heat transfer methods will generally heat the substrate and deposited material at similar rates. In cases where the substrate conductivity is relatively high, such as silicon substrates, the temperature uniformity across the substrate will remain relatively uniform. The convective heat transfer rate can also be easily controlled by adjusting the flow rate and/or the temperature of the convective gas.

Referring to FIG. 6, the convective heating assembly 203 generally comprises a fluid transferring device 229, a plenum 245 and a gas heating assembly 240. A substrate disposed in the processing region 202 is thus heated by directing the gas provided from the fluid transferring device 229 through the heating assembly 240 and past a surface of the substrate 30. In one embodiment, the fluid transferring device 229 is an AC fan that can deliver a desired flow rate of gas (see path “B”) through the radiant heating assembly 204 and into the processing region 202.

The gas heating assembly 240 generally contains one or more resistive heating elements positioned in a heated zone 241 that is adapted heat the gas delivered from the fluid transferring device 229. The temperature of the gas exiting the gas heating assembly 240 may be controlled by use of a conventional heating element temperature controller 242, one or more conventional temperature sensing devices (not shown), resistive heating elements (not shown) positioned in the heating zone 241, and commands sent from the system controller 101. In one embodiment, the gas temperature at the exit of the gas heating assembly 240 is controlled to between about 150° C. and about 300° C.

The plenum 245 is generally an enclosed region that is used to direct the gas delivered from fluid transferring device 229 through the gas heating assembly 240, into the plenum exit section 243 and then through the processing region 202. In one embodiment, the plenum 245 may also contain a plenum inlet section 244 that is adapted to receive the gas transferred through the processing region 202 to provide a gas return, or re-circulation path, so that heated gas, such as air, can be collected and reused.

In an alternate embodiment of the convective heating assembly 203, as shown in FIG. 6, the gas returning from the processing region 202 (i.e., paths A₅ and A₆) is not recirculated. In this configuration, the gas exiting the fluid transferring device 229 (e.g., path “B”) enters an inlet plenum 249A passes through a plurality of heat exchanging tubes 248 and enters the exit plenum 249B before it is delivered through the gas heating assembly 240 and processing region 202. The heat exchanging tubes 248 are generally sealed so that the gas following along path “B” passes through an internal region 248A of the tube and does not mix with the gas returning from the processing region 202. In one configuration, the gas returning from the processing region 202 along paths A₅ and A₆ passes by the external surfaces of the heat exchanging tubes 248 before it is exhausted from the thermal system 201 through a port 247. Therefore, by controlling the temperature of the heat exchanging tubes 248 using the thermal controller 231, the temperature of the gas flowing from the fluid transferring device 229 to the gas heating assembly 240 can be preheated, and the gas returning from the processing region 202 can be cooled to remove any entrained volatile components. Preheating the gas before it enters the gas heating assembly 240 may also help improve the gas heating efficiency and thus reduce the power consumption of the drying process performed in the drying chamber. In general, the thermal controller 231 is adapted to keep the temperature of the surfaces of the heat exchanging tubes 248 (i.e., heat exchanging surfaces 232) at a temperature below the temperature of the heated gas delivered to the processing region 202 (e.g., <219° C.) to condense and remove any volatile components contained in the gas flowing along path A₆. In one embodiment, the heat exchanging surfaces 232 are maintained at a temperature between about 40° C. and about 80° C. to condense the vapor material entrained in the recirculated gas. Due to gravity the volatile components that condense on the heat exchanging tubes 248 will flow to (i.e., path “C”) and be collected within a fluid collection region 233 of the plenum 245. The fluid collection region 233 may contain one or more drains that are used to deliver the collected vapor material to a waste collection system (not shown). Since energy consumption is often an important factor in the cost to produce a solar cell device, the methods of preheating and/or recirculating the gas discussed herein can help reduce the cost of ownership of a screen printing production line and thus the formed device's production cost.

In one embodiment, the cluster tool 10 comprise a plurality of work stations 11, normally three in number, typically to perform the steps of metalizing the front surface of the substrate (e.g., screen print silver), a second metalizing step in which a second metal layer is deposited on the rear surface of the substrate (e.g., screen print silver), and a third step in which a third metal layer (e.g., screen print aluminum) is deposited on the rear surface of the substrate.

In one embodiment, the cluster tool 10 also comprises a sintering oven 15, disposed downstream of the plurality of first work stations 11, in which the substrates are subjected to a sintering process. The sintering oven may comprise a series of infra-red (IR) heaters or other types of heating elements that are adapted to heat the deposited layers on the substrate to a temperature that causes the layer to fuse and/or densify portions of the deposited layer (e.g., conductor tracks 31). Generally, the oven processing temperature is at or below the melting point of the material(s) found in the deposited layer. In one example, the sintering oven 15 is similarly configured like the drying oven 14.

The cluster tool 10 may also comprise a testing station 16, to carry out a quality test on the substrates produced in the previous work stations, and at least a storage station 17 in which the substrates are stored according to their quality class. One will note that a work station 11 comprising the sintering oven 15, the testing station 16 and the storage station 17 will be referred to, hereafter, as a production station 25.

Referring to FIGS. 1-2, and 4-7, in one embodiment, the cluster tool 10 has an automation assembly 50 that comprises an electromagnetic guide 18 and a plurality of transport shuttles 20. In one embodiment, the electromagnetic guide 18, such as a rail which passes through all of the work stations 11 and/or production stations 25, is generally used to support and guide the plurality of transport shuttles 20. The electromagnetic guide 18 generally defines a substantially closed circuit 19, on which a plurality of transport shuttles 20 are able to move by use of commands sent from the system controller 101. To achieve a high productivity, the transport shuttles 20 are adapted transfer the substrates at a high speed along the length of the electromagnetic guide 18. In general, the cluster tool 10 may also comprise a loading/unloading station 9 that is adapted to load, or unload, a substrate to, or from, each of the transport shuttles 20 by use of a standard conveyor system 7 (FIG. 1) that is coupled to a substrate cassette 8 (e.g., wafer cassette, stack box). Each transport shuttle 20 is thus able to transport a corresponding substrate from one work station to the next along the electromagnetic guide 18.

In one embodiment, as shown in FIG. 7, the transport shuttle 20 comprises a frame assembly 21 that further comprises a lower support frame assembly 21A that is shaped so as to engage with portions of the electromagnetic guide 18. In one embodiment, the lower support frame assembly 21A is a structural element (e.g., metallic frame) that rests on bearing elements 21B (e.g., roller bearings, rails, guide wheels) that allow the lower support frame assembly 21A to freely move relative to the stationary electromagnetic guide 18. In general, the frame assembly 21 also comprises a platen assembly 27 that is used to support a substrate 30 that is disposed on a belt 22, which is contained in a conveyor assembly 23. The electromagnetic guide 18 may also generally comprises a drive member, such as a linear motor 21C, that is used to actively position the frame assembly 21 at desired locations along the length of the electromagnetic guide 18 by use of commands sent from the system controller 101. The electromagnetic guide 18 may also comprise a series of conventional slip rings, brushes, electrical interface components, cable trays or other conventional support circuit containing elements that are adapted to deliver signals and power to one or more components found in transport shuttle 20.

As illustrated in FIG. 7, each transport shuttle 20 generally consist of a conveyor assembly 23 that has idler pulleys 23A, a feed spool 23B, a take-up spool 23C, and one or more actuators (not shown) that are coupled to the feed spool 23B and/or take-up spool 23C, and are adapted to feed and position the belt 22 positioned across the platen 27. In general, the conveyor assembly 23 and platen 27 are supported by the frame assembly 21, which is coupled to the electromagnetic guide 18 through the bearing elements 21B. The platen 27 generally has a substrate supporting surface (e.g., top surface in FIG. 7) on which a substrate 30 and a belt 22 are disposed while the substrate 30 is transported through the cluster tool 10. In one embodiment, the belt 22 is a porous material that allows a substrate 30, which is disposed on one side of the belt 22, to be retained on the substrate supporting surface of the platen 27 by a vacuum applied to the opposing side of the belt 22 by a conventional vacuum generating device (e.g., vacuum pump, vacuum ejector). In one embodiment, a vacuum is applied to vacuum ports (not shown) formed in the substrate supporting surface of the platen 27 so that the substrate can be “chucked” to a surface of the belt 22, which is disposed over the substrate supporting surface during processing and movement through the cluster tool. In one embodiment, the belt 22 is a transpirable material that consists, for instance, of a transpirable paper of the type used for cigarettes or another analogous material or of a material which performs the same purpose.

In one embodiment, the transport shuttle 20 also contains a heating member 24 that is provided to heat a substrate disposed on the platen 27. In one embodiment, the heating member 24 is a lamp, heating element or other similar device that is close loop controlled using a temperature sensor (not shown), such as a thermocouple, and the system controller 101. During processing the system controller 101 and the heating member 24 are used in combination to deliver a desired amount of heat to platen 27, so that the temperature of a substrate positioned on the belt 22 can be controlled. The temperature of the substrate may be manually, or automatically controlled, according to the specific operating conditions of the various work stations, the type of substrate, the layers formed on the substrate, or other parameters programmed or programmable in the system controller 101.

In one configuration of the frame assembly 21, the platen 27, and thus the upper surface of the transport shuttle 20, is rear-lit by use of a lamp 29 to promote the inspection processes performed in the automatic optical inspection station 13.

In one embodiment, the lamp 29 is a broad band light source that is adapted to emit one or more wavelengths of light that can be detected by the camera found in the optical inspection station 13. In an effort to track the substrate movement, processing information and other substrate specific information, each substrate 30 may be provided with identification means, such as a RF-ID TAG, bar code or other similar processing device that is able to be recognized by a corresponding recognition device disposed in each of the work stations. In one example, a radiofrequency type, magnetic induction, or other similar type of device is used to continuously control the location of the substrate in the cluster tool 10. The collected data relating to each specific substrate (e.g., ID information, processing information created in each work station) can thus be collected and stored in the memory of the system controller 101 for future use and analysis.

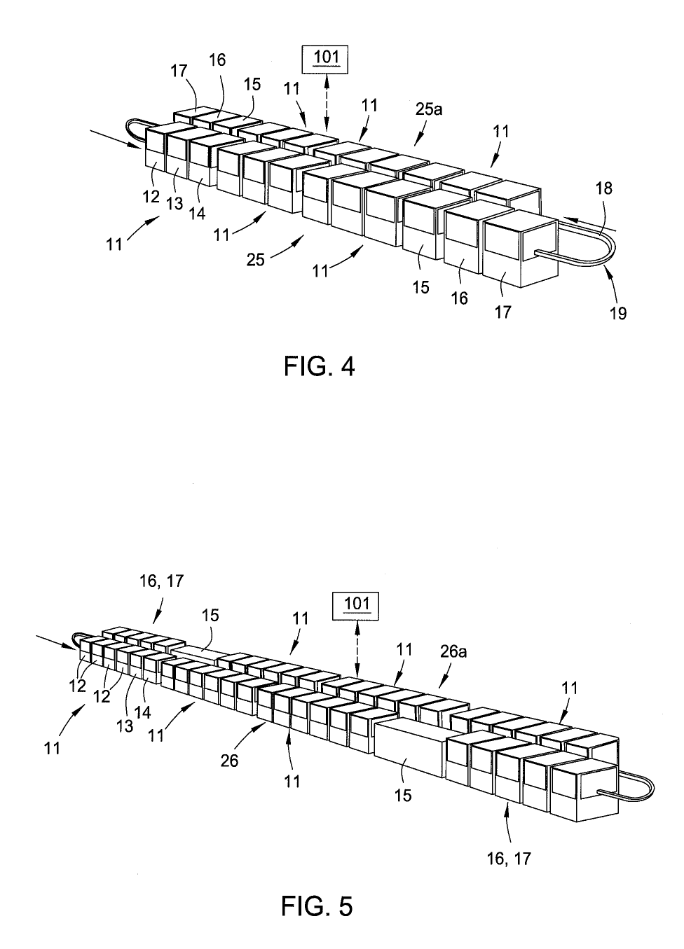

According to a variant of the present invention, as shown in FIG. 4, the transport shuttle 20 is moved along a circuit 19 formed within the cluster tool 10. The circuit 19 may comprise the electromagnetic guide 18 and two or more production stations 25 and/or work stations 11. In one embodiment, the cluster tool 10 also comprises a production station 25a that is coupled to the circuit 19, which is a mirror image or replica of the production station 25.

According to another variant of the present invention, as shown in FIG. 5, the cluster tool 10 comprises a circuit 19 having a production station 26 in which each work station 11 disposed therein has a plurality of deposition stations 12 that are coupled to the electromagnetic guide 18. In one example, a production station 26 has four deposit stations 12 disposed along the electromagnetic guide 18. In one embodiment, the cluster tool 10 also comprises a production station 26a that is coupled to the circuit 19, which is a mirror image or replica of the production station 26.

In one embodiment, a processing sequence performed in the cluster tool 10 may function as follows. First, the transport shuttles 20 is positioned by use of commands sent from the system controller 101 to receive a substrate 30 from a standard conveyor system 7 disposed in the loading/unloading station 9 (FIG. 1). Once the frame assembly 21 in the transportation shuttle 20 is aligned with the conveyer system 7, the belt 22 in the transportation shuttle 20 and belt in the conveyer system 7 are cooperatively moved to load the substrate 30 onto the platen 27. After the substrate 30 is positioned on the platen 27 the transportation shuttle 20 and substrate 30 are moved at high speed from one work station to the next by use of commands sent from the system controller 101 so that the various processes can be performed on the substrate that is disposed on the transportation shuttle 20. After all of the processes have been performed on the substrate in the various work stations 11, production stations 25, 26, or combination thereof, the substrate is then transferred to a loading/unloading station 9. In this case, once the frame assembly 21 in the transportation shuttle 20 is aligned with the conveyer system 7, the belt 22 in the transportation shuttle 20 and belt in the conveyer system 7 are cooperatively moved to unload the substrate 30 from the platen 27 to the conveyor system 7.

In one embodiment, with reference to FIG. 4, the movement of the transportation shuttles 20 through the cluster tool 10 are linked so that the advance of a first transport shuttle 20 along the production station 25 corresponds to a similar advance of a corresponding second transport shuttle 20 along the production station 25a, so that the substrates disposed respectively on the first and second transport shuttles are processed in a similar manner. This processing configuration achieves a parallel processing of the substrates, which can allow double the production capacity of the cluster tool 10, given the same working times, with respect to the cluster tool in FIG. 1.

In one embodiment, as shown in FIG. 5, the movement of the transportation shuttles 20 through the cluster tool 10 are linked so that the advance of the transport shuttles 20 through the two production stations 26 and 26a, such that a simultaneous advance is achieved through the plurality of metal deposit stations 12, so that at least one substrate is subjected to processing in each of the metal deposition stations 12. Therefore, during the processing time of a single substrate, a plurality of substrates are processed.

The cluster tool 10 is generally modular in nature and is able to satisfy different requirements of production capacity.

It is clear that modifications and/or additions of parts may be made to the cluster tool 10 for working substrates for electronic circuits as described heretofore, without departing from the field and scope of the present invention.

It is also clear that, although the present invention has been described with reference to some specific examples, a person of skill in the art shall certainly be able to achieve many other equivalent forms of cluster tool for working substrates for electronic circuits, having the characteristics as set forth in the claims and hence all coming within the field of protection defined thereby.

1. A cluster tool that is configured to process a plurality of substrates, comprising:
an automation assembly (50) comprising:
a plurality of transport elements (20) that each have a substrate supporting surface; and
a guide (18) forming a substantially closed circuit (19) within the cluster tool, and having an actuator (21C) that is adapted to move the plurality of transport elements (20) along the substantially closed circuit (19);
at least one deposition station (12) that is adapted to deposit a layer on a surface of a substrate disposed on a substrate supporting surface of a transport element (20);
at least one drying oven (14) that is adapted to dry the deposited layer formed on the substrate disposed on the substrate supporting surface of the transport element (20); and
an inspection station (13) that is adapted to optically inspect a surface of the substrate disposed on the substrate supporting surface of the transport element (20).

2. The cluster tool of claim 1, further comprising:
at least one testing station (16) to test said substrates; and
at least a storage station (17) to store the substrates.

3. The cluster tool of claim 1, further comprising a sintering oven (15) that is configured to process a substrate disposed on the substrate supporting surface of the transport element (20).

4. The cluster tool of claim 1, wherein the transport elements (20) further comprises:
a platen (27) on which the substrate supporting surface is formed;
a feed spool (23B);
a take-up spool (23C); and
a belt (22) that is coupled to the feed spool (23B) and the take-up spool (23C), and is disposed across the substrate supporting surface of the platen (27)

5. The cluster tool of claim 4, wherein the belt (22) is formed from a porous material.

6. The cluster tool of claim 1, wherein the at least one drying oven (14) further comprises:
a radiant heat transfer assembly (204) that is adapted to deliver electromagnetic energy at one or more wavelengths to the substrates positioned on the substrate supporting surface of a transport element (20); and
a convective heat transfer assembly (203) comprising:
a plenum (240) having a heating element (241) disposed therein; and
a fluid delivery device (229) that is configured to move a gas past the heating element (241) disposed in the plenum, and past a surface of the substrate positioned on the substrate supporting surface of the transport element (20).

7. The cluster tool of claim 1, wherein at least one of the plurality of transport elements (20) comprises a lamp (29) that is disposed adjacent to a surface of the platen (27) that is on a side of the platen that is opposite to the substrate supporting surface.

8. The cluster tool of claim 1, wherein at least one of the plurality of transport elements (20) comprises a heating element that is adapted to heat a substrate disposed on the substrate supporting surface.

9. The cluster tool of claim 1, further comprising a plurality of recognition devices that each are in communication with a system controller, wherein the each of the recognition devices are adapted to recognize an identification element disposed on a substrate.

10. A method of processing a substrate, comprising:
positioning a substrate on a substrate supporting surface formed on a transport element (20), wherein positioning a substrate comprises:
receiving a substrate on a first surface of a belt (22) that is disposed over the substrate supporting surface; and
moving the belt (22) across the substrate supporting surface;
transferring the substrate disposed on the first surface of the belt (22) along a closed circuit (19) formed along a guide (18);
depositing a material layer on a surface of the substrate disposed on the substrate supporting surface of the transport element (20);
transferring the substrate disposed on the substrate supporting surface of the transport element (20) to a processing region of a drying chamber after depositing the material layer; and
delivering an amount of electromagnetic energy to a surface of the substrate positioned on the substrate supporting surface of the transport element (20).

11. The method of claim 10, further comprising delivering a heated gas past the surface of the substrate positioned on the substrate supporting surface of the transport element (20).

12. The method of claim 10, wherein depositing a material layer on a surface of the substrate comprises depositing the material layer on the substrate using a screen printing process.

13. The method of claim 10, further comprising inspecting a first substrate disposed on the substrate supporting surface of the transport element (20) using a camera disposed in an inspection station (13) after depositing the material layer.

14. The method of claim 10, further comprising sintering the material layer deposited on the surface of the substrate disposed on the substrate supporting surface of the transport element (20).

15. The method of claim 10, further comprising heating a substrate disposed on the substrate supporting surface using a heating element disposed in the transport element (20), while the transport element (20) is transferred along the guide (18).

16. The method of claim 10, further comprising recognizing an identification element disposed on the substrate that is disposed on the substrate supporting surface of the transport element (20) as the transport element (20) is transferred along the guide (18).
